(19) United States
(12) Patent Application Publication
(10) Pub. No.: US 2010/0157571 A1
(43) Pub. Date: Jun. 24, 2010

(54) ILLUMINATION DEVICE WITH SELECTIVE COLOR OUTPUT

(75) Inventor: CHIH-MING LAI, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/512,231

(22) Filed: Jul. 30, 2009

(30) Foreign Application Priority Data
Dec. 24, 2008 (CN) 200810306516.3

(51) Int. Cl. F21V 9/16; F21S 6/00

(52) U.S. Cl. 362/84; 362/257

(57) ABSTRACT

An exemplary illumination device includes a light source and a light-pervious optical wavelength converting barrel. The light source is configured for emitting monochromatic light. The light-pervious optical wavelength converting barrel includes a plurality of optical wavelength converting regions. The optical wavelength converting regions are sequentially arranged to cooperatively form an accommodating space receiving the light source. In operation, the barrel is rotatable relative to the light source, such that each of the optical wavelength converting regions is capable of being selectively positioned to receive the light from the light source. Thereby, the illumination device emits light with a converted wavelength.

### BACKGROUND

1. Technical Field

The disclosure generally relates to illumination devices, and particularly to an illumination device capable of selectively emitting light of desired colors.

2. Description of Related Art

Light emitting diodes (LEDs) have recently been used extensively as light sources for illumination devices due to their high luminous efficiency, low power consumption and long lifespan. A plurality of LEDs each with different colors and wavelengths may be employed in a single illumination device, such that the illumination device can illuminate colorful light. In these types of illumination devices, the LEDs are generally controlled to blink and/or flash at selected time intervals. This is achieved by employing a complex control circuit electrically connected to the LEDs. Thus the illumination device is able to mix light and provide different colored light at different times. However, the complex control circuit is typically expensive and not cost effective.

Therefore, what is needed is an illumination device that overcomes the described limitations.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic, exploded view of an illumination device, according to a first embodiment.

FIG. 2 is an enlarged cross section of an optical wavelength converting barrel of the illumination device of FIG. 1, taken from line II-II thereof.

FIG. 3 is an assembled view of the illumination device of FIG. 1.

FIG. 4 is a cross section of the illumination device of FIG. 3, taken from line IV-IV thereof.

FIG. 5 is a schematic view of an illumination device, according to a second embodiment.

### DETAILED DESCRIPTION

Reference will now be made to the drawings to describe various embodiments of the illumination device, in detail.

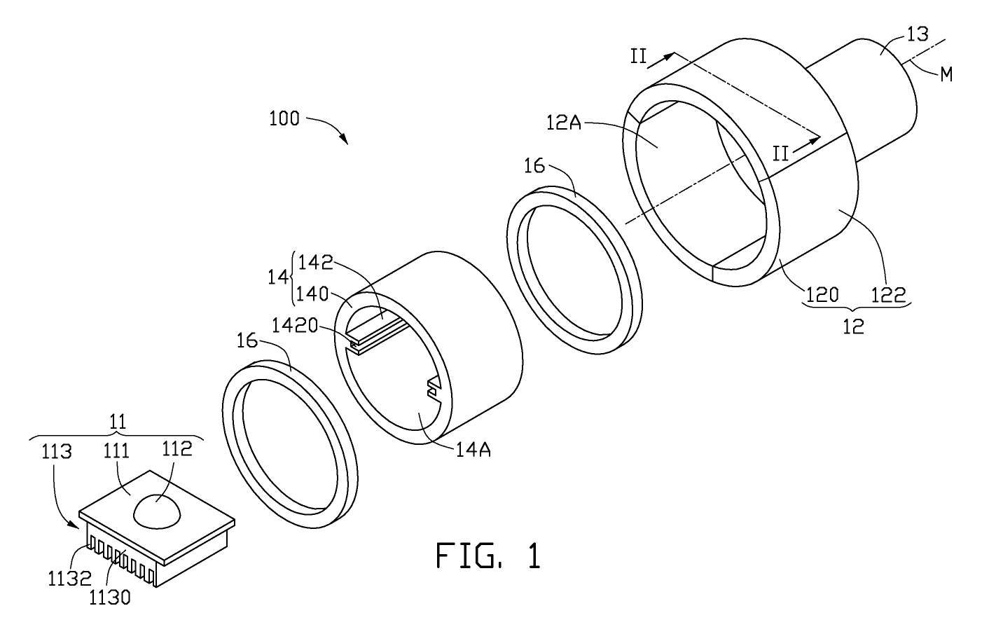

Referring to FIG. 1, an illumination device 100, according to a first embodiment, includes a light source 11 and an optical wavelength converting barrel 12 arranged around the light source 11. The illumination device 100 may further include an actuator 13 for rotating the optical wavelength converting barrel 12 or the light source 11.

The light source 11 includes a substrate 111, and at least one LED 112 arranged on the substrate 111. In the first embodiment, one LED 112 is provided to emit monochromatic light. The monochromatic light can for example be blue light having a wavelength in a range from 410 nanometers (nm) to 490 nm, for instance 465 nm. The Full Width at Half Maximum (FWHM) of the blue light is no more than 30 nm. In another example, the monochromatic light can be ultraviolet (UV) light. The substrate 111 can be a circuit board securing the LED 112 thereon. Heat generated by the LED 112 can be firstly transmitted to the substrate 111, and then dissipated to ambient air. The light source 11 may further include a heat dissipation device 113 for accelerating dissipation of the heat from the LED 112. The heat dissipation device 113 can, for example, include a base 1130 that contacts a side of the substrate 111 away from the LED 112, and a plurality of fins 1132 extending from the base 1130. In operation of the heat dissipation device 113, heat is transmitted from the substrate 111 to the fins 1132 through the base 1130. The fins 1132 increase an overall heated surface area that is in contact with the ambient air, thereby improving the heat dissipating efficiency.

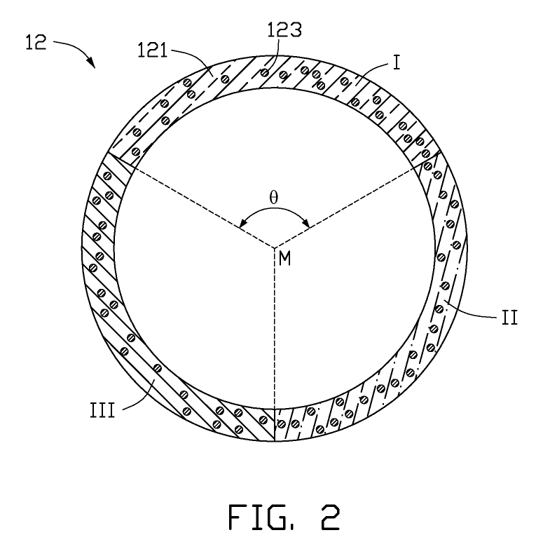

Referring also to FIG. 2, the optical wavelength converting barrel 12 includes a generally light-pervious substrate 121, and at least one optical wavelength converting material 123 mixed in a base material of the substrate 121. In the present embodiment, the at least one optical wavelength converting material 123 is mixed essentially uniformly in the base material of the substrate 121. The base material of the substrate 121 can be made of resin, silicone, glass, epoxy, polyethylene terephalate, polymethyl methacrylate, or polycarbonate. The at least one optical wavelength converting material 123 is in the form of particles, and may include one kind of phosphor or different kinds of phosphors. The phosphor or phosphors can, for example, be red phosphor 123, yellow phosphor 123, green phosphor 123, or phosphors having other types of colors. The phosphor or phosphors may be comprised of one of sulfides, aluminates, oxides, silicates and nitrides. For example, the phosphor or phosphors may be Ca₂Al₁₂O₁₉:Mn, (Ca, Sr, Ba)Al₂O₄:Eu, CdS, CdTe, Y₃A₁₅O₁₂Ce³⁺(YAG), Tb₃Al₅O₁₂:Ce³⁺(YAG), BaMgAl₁₀O₁₇:Eu²⁺(Mn²⁺), Ca₂Si₅N₈:Eu²⁺, (Ca, Sr, Ba)S:Eu²⁺, (Mg, Ca, Sr, Ba)₂SiO₄:Eu²⁺, (Mg, Ca, Sr, Ba)₃Si₂O₇:Eu²⁺, Y₂O₂S:Eu³⁺, Ca₈Mg(SiO₄)₄Cl₂:Eu²⁺, (Sr, Ca, Ba)SiₓO_{y}N_{z}:Eu²⁺, (Ca, Mg, Y)SiwAlₓO_{y}N_{z}:Eu²⁺, or CdSe.

The optical wavelength converting barrel 12 includes a plurality of optical wavelength converting regions; for example, a first region I, a second region II, and a third region III, as shown in FIG. 2. The optical wavelength converting regions I, II, III are sequentially arranged around a central axis M of the optical wavelength converting barrel 12 to cooperatively form a first accommodating space 12A for receiving the light source 11. In this embodiment, the optical wavelength converting barrel 12 is in the form of a first cylinder having the first accommodating space 12A defined therein. The optical wavelength converting barrel 12 includes a first end 120 and a second end 122 at opposite sides thereof. The first end 120 is open, with the first accommodating space 12A being exposed to an exterior of the optical wavelength converting barrel 12 thereat. The second end 122 is closed. Each of the first, second, and third regions I, II, III spans through an entire axial length of the optical wavelength converting barrel 12 including both the first end 120 and the second end 122. A transverse cross section of each region I, II, III (e.g., the first region I) is part of an annulus. Said part of an annulus subtends a central angle θ, as shown in FIG. 2. The central angle θ0 may be equal to a viewing angle of the LED 112. For example, if the LED 112 has a viewing angle of 120 degrees, the optical wavelength converting barrel 12 can be divided into three regions (i.e., the first, second, and third regions I, II, III), with each part of the annulus subtending the same central angle θ in the amount of 120 degrees.

Each of the first, second, and third regions I, II, III includes a part of the light-pervious substrate 121 having the optical wavelength converting material 123 mixed therein. In this embodiment, the first region I has red phosphor 123 essentially uniformly mixed therein, the second region II has yellow phosphor 123 essentially uniformly mixed therein, and the third region III has green phosphor 123 essentially uniformly mixed therein. The concentration of the red phosphor 123 in the first region I is substantially the same as each of the concentration of the yellow phosphor 123 in the second region II and the concentration of the green phosphor 123 in the third region III. In alternative embodiments, each of the first, second, and third regions I, II, III may have a concentration of optical wavelength converting material 123 different from that of each of the other two regions I, II, and/or III. In other alternative embodiments, only one or two of the first, second, and third regions I, II, III may have the optical wavelength converting material 123 mixed therein; with the other two or sole region(s) I, II, and/or III only having the light-pervious substrate 121 and not having any optical wavelength converting material 123 mixed therein. In still other alternative embodiments, the phosphor or phosphors of the optical wavelength converting material 123 of each of the first, second, and third regions I, II, III may be different from the phosphor or phosphors of the optical wavelength converting material 123 of all of the other first, second, and third regions I/II/III.

It is noted that in other further or alternative embodiments, the optical wavelength converting material 123 need not be mixed in the base material of the substrate 121. Instead, in one example, the optical wavelength converting material 123 can be formed on either or both of an interior surface and an exterior surface of the substrate 121.

The illumination device 100 may further include a bracket 14 for holding the light source 11. The bracket 14, for example, may include a main body 140 having a second accommodating space 14A therein, and two supporting portions 142. In this embodiment, the main body 140 is in the form of a second cylinder having the second accommodating space 14A defined therein. The main body 140 has two opposite ends, at each of which the second accommodating space 14A is exposed to an exterior of the main body 140. The two supporting portions 142 extend from two opposite inner sides of the main body 140. Each of the two supporting portions 142 has an elongated groove 1420 defined therein, for fittingly receiving a corresponding side edge of the substrate 111. The bracket 14 can made of light-pervious material, such as resin, polymer or glass, etc.

The actuator 13 can be a motor with a central shaft (not visible). The shaft of the motor is coaxial with the central axis M of the optical wavelength converting barrel 12.

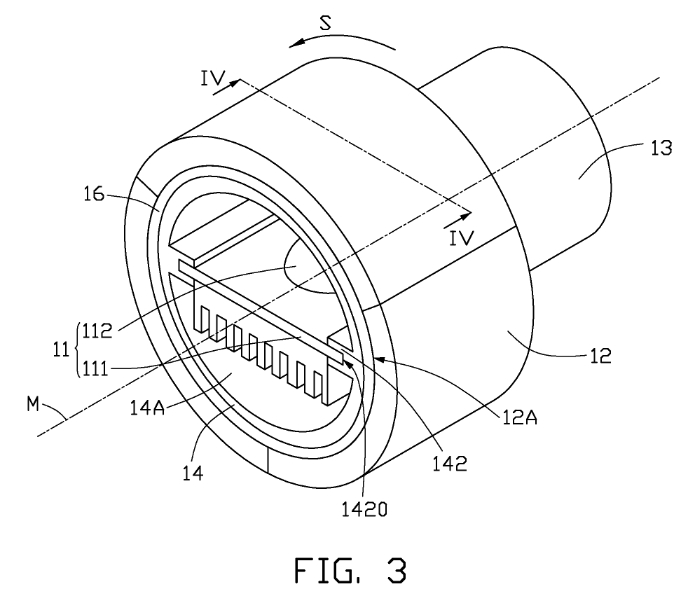

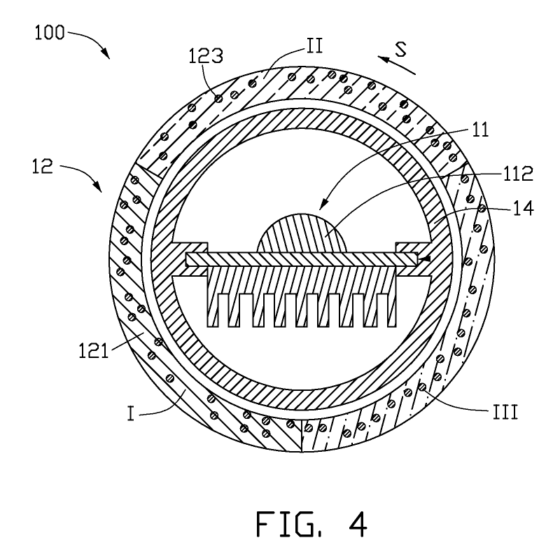

Referring also to FIGS. 3 and 4, in assembly, by sliding the two opposite side edges of the substrate 111 into the two elongated grooves 1420 of the supporting portions 142, the light source 11 can be held by the bracket 14 in the second accommodating space 14A. Then the bracket 14 together with the light source 11 can be received in the first accommodating space 12A of the optical wavelength converting barrel 12, with the LED 112 positioned on, at or adjacent to the central axis M of the optical wavelength converting barrel 12. In the illustrated embodiment, an imaginary center axis of the substrate 111 is coaxial with the central axis M. Accordingly, an imaginary diameter of a base surface of the LED 112 is near and parallel to the central axis M. In addition, the actuator 13 can be coupled to the second end 122 of the optical wavelength converting barrel 12, as shown in FIG. 3. Furthermore, two bearings 16 can be provided. The bearings 16 are mounted between the main body 140 and the optical wavelength converting barrel 12 at the first end 120 and the second end 122, respectively. Thereby, the bracket 14 is rotatably coupled to the optical wavelength converting barrel 12 through the bearings 16.

Referring to FIG. 4, in a typical application, the bracket 14 with the light source 11 held thereon is fixed to another object (not shown). The actuator 13 rotates the optical wavelength converting barrel 12 counter-clockwise (as viewed in FIG. 4, shown by the arrow S). Thus, one or two of the optical wavelength converting region(s) I, II, III can be selectively arranged opposite to the LED 112. The selected optical wavelength converting regions I/II/III thereby receive the light emitted from the light source 11, and convert the wavelength of the light accordingly. For example, as shown in FIG. 4, the optical wavelength converting region II is rotated to face the LED 112. The yellow phosphor 123 of the optical wavelength converting region II absorbs blue light emitted from the LED 112 and transmitted through the light-pervious bracket 14, and converts the wavelength of the blue light into the wavelength of yellow light to a certain degree. For example, the blue light and the yellow light mix to form colorful light having different colors or/and chromas. In another example, the blue light is completely absorbed by the yellow phosphor 123 of the optical wavelength converting region II, with the wavelength of the blue light being completely converted into the wavelength of yellow light. Accordingly, the illumination device 100 emits yellow light.

In alternative embodiments, the region II includes only the base material of the substrate 121, without any optical wavelength converting material 123 mixed therein. In such case, the blue light may transmit directly through the optical wavelength converting barrel 12, such that the illumination device 100 emits blue light. In yet other alternative embodiments, the actuator 13 may be coupled to the bracket 14. Accordingly, in operation, the optical wavelength converting barrel 12 is fixed to an object (not shown), and the actuator 13 rotates the bracket 14 with the light source 11 held therein. The LED 112 can thus be selectively positioned opposite to one or two of the optical wavelength converting regions I, II, III. In still other alternative embodiments, the illumination device 200 may include a plurality of LEDs 112 arranged along the central axis M of the optical wavelength converting barrel 12.

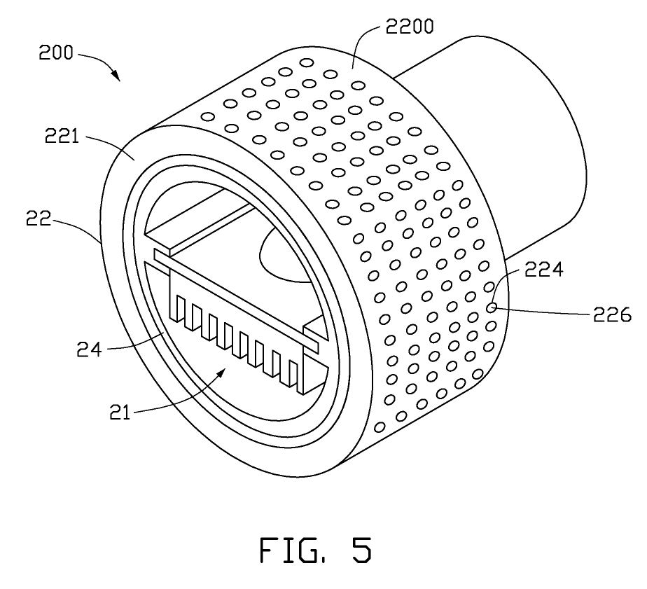

Referring to FIG. 5, an illumination device 200, according to a second embodiment, includes a light source 21, an optical wavelength converting barrel 22 and a bracket 24.

The light source 21 is similar to the light source 11 of the first embodiment. The bracket 24 is similar to that the bracket 14 of the first embodiment.

The optical wavelength converting barrel 22 includes a substrate 221 having a cylindrical exterior surface 2210. The optical wavelength converting barrel 22 is similar in principle to the optical wavelength converting barrel 12. However, a plurality of grooves 224 is defined in the exterior surface 2200, and each of the grooves 224 is filled with an encapsulant material 226. In the illustrated embodiment, the grooves 224 are substantially evenly distributed throughout the exterior surface 2210. Optical wavelength converting material (not shown) is embedded (i.e., mixed or enclosed) in the encapsulant material 226 (not in a base material of the substrate 221). The encapsulant material 226 may for example be ultraviolet adhesive. The encapsulant material 226 protects the optical wavelength converting material from contacting air. Thus, the working lifetime of the optical wavelength converting material is extended.

In summary, the illumination devices 100, 200 are equipped with optical wavelength converting barrels 12, 22 having a plurality of optical wavelength converting regions, and each of the optical wavelength converting regions is rotatable relative to the light sources 11, 21, such that a selected one or two of the optical wavelength converting regions is positioned opposite to the light sources 11, 21. Thus the color or/and chroma of the illumination device 100, 200 can be flexibly changed according to different requirements, thereby providing rich and colorful illuminating effects as desired.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. An illumination device, comprising:
a light source configured for emitting monochromatic light; and
a light-pervious optical wavelength converting barrel comprising a plurality of optical wavelength converting regions, the optical wavelength converting regions being sequentially arranged to cooperatively form an accommodating space receiving the light source, and the barrel being rotatable relative to the light source such that each of the optical wavelength converting regions is capable of being selectively positioned to receive the light from the light source and thereby emit light with a converted wavelength from the illumination device.

2. The illumination device of claim 1, wherein the barrel is substantially a cylinder having the accommodating space defined therein, and the barrel includes a first end and a second end at two opposite sides thereof, with each of the optical wavelength converting regions spanning through substantially an entire axial length of the barrel including both the first end and the second end.

3. The illumination device of claim 2, wherein the light source comprises at least one light emitting diode positioned at a central axis of the barrel.

4. The illumination device of claim 3, wherein a transverse cross section of each region is part of an annulus subtending a central angle measured at the central axis, and each part of the annulus subtends the same central angle, which is substantially equal to a viewing angle of the at least one light emitting diode.

5. The illumination device of claim 3, wherein the light source further comprises a circuit board securing the at least one light emitting diode thereon.

6. The illumination device of claim 2, further comprising a light-pervious bracket holding the light source in the accommodating space.

7. The illumination device of claim 6, wherein the bracket is made of material selected from the group consisting of resin, polymer, and glass.

8. The illumination device of claim 6, further comprising an actuator structured and arranged for rotating one of the barrel and the bracket relative to the other of the barrel and the bracket.

9. The illumination device of claim 8, wherein the actuator comprises a motor.

10. The illumination device of claim 6, wherein the bracket comprises a cylindrical main body and two supporting portions extending from two opposite inner sides of the main body, the main body received in the barrel, and the supporting portions holding the circuit board.

11. The illumination device of claim 10, further comprising two bearings mounted between the main body and the barrel at the first end and the second end of the barrel, respectively, the bracket being rotatably coupled to the barrel through the bearings.

12. The illumination device of claim 9, wherein the barrel comprises a substrate comprising a light-pervious base material, and each of the optical wavelength converting regions comprises part of the substrate and optical wavelength converting material essentially uniformly distributed at a location selected from the group consisting of mixed in the base material of the part of the substrate and at a surface of the base material of the part of the substrate.

13. The illumination device of claim 12, wherein the optical wavelength converting material is essentially uniformly distributed at an exterior surface of the base material of the part of the substrate, the exterior surface has a plurality of grooves defined therein, and the optical wavelength converting material is embedded in an encapsulant material that fills the grooves.

14. The illumination device of claim 12, wherein the base material of the part of the substrate is selected from the group consisting of resin, silicone, glass, polyethylene terephalate, polymethyl methacrylate, and polycarbonate.

15. The illumination device of claim 12, wherein the optical wavelength converting material is phosphor, which is comprised of at least one of sulfides, aluminates, oxides, silicates and nitrides.

16. The illumination device of claim 15, wherein the optical wavelength converting material of all of optical wavelength converting regions is the same phosphor, and each optical wavelength converting region has a concentration of the phosphor different from that of each other optical wavelength converting region.

17. The illumination device of claim 15, wherein the optical wavelength converting material of each of the optical wavelength converting regions is a phosphor different from the phosphor of each other optical wavelength converting region.

18. An illumination device, comprising:
a light source configured for emitting monochromatic light;
a light-pervious optical wavelength converting barrel comprising a plurality of optical wavelength converting regions, the optical wavelength converting regions being sequentially arranged to cooperatively form an accommodating space receiving the light source; and
an actuator structured and arranged for rotating one of the light source and the optical wavelength converting barrel relative to the other of the light source and the optical wavelength converting barrel fixed, such that each of the optical wavelength converting regions is capable of being selectively positioned to receive the light from the light source and thereby emit light with a converted wavelength from the illumination device.

19. The illumination device of claim 18, wherein the optical wavelength converting barrel is substantially a cylinder having the accommodating space defined therein, and the optical wavelength converting barrel includes a first end and a second end at two opposite sides thereof, with each of the optical wavelength converting regions spanning through substantially an entire axial length of the optical wavelength converting barrel including both the first end and the second end.

20. The illumination device of claim 18, further comprising a light-pervious bracket holding the light source in the accommodating space, the bracket and the light source being non-rotatable relative to each other.
